(19) United States
(12) Patent Application Publication
(10) Pub. No.: US 2012/0055317 A1
(43) Pub. Date: Mar. 8, 2012

(54) SWITCH WITH SOUNDS

(76) Inventor: Oliver SIR, Magalia, CA (US)

(21) Appl. No.: 12/875,135

(22) Filed: Sep. 3, 2010

(51) Int. Cl. G10G 1/00

(52) U.S. Cl. 84/462

(57) ABSTRACT

A switch with sounds includes a switch body provided therein with a recording device and a time controller. In using, a piece of sounds or music a user likes is recorded beforehand by the recording device, and then the length of time for sending forth the sounds or the music is preset by the time controller. When the switch body is turned on, the recording device will be started to send out the sounds or the music recorded in advance, and the sounds or the music will not stop until the time preset on the time controller, able to make a user relaxed and happy when turning on the switch, and hence eliminate dull and monotonous impression during turning on a conventional switch.

### BACKGROUND OF THE INVENTION

1. Field of the Invention

This invention relates to a switch with sounds, particularly to one able to send out pleasant sounds or music to make a person relaxed and happy when he turns on the switch.

2. Description of the Prior Art

Generally, a conventional switch is only used for turning on or turning off various kinds of electric appliances but has no other function. In the society of today, most people are busy working all day long, and at the moment when a person comes back home, he may find that the house is soundless and feel lonely. In view of the monotony of the conventional switch, a switch with sounds is devised by the inventor of this invention for making a person relaxed and happy when he turns on the switch.

### SUMMARY OF THE INVENTION

The objective of this invention is to offer a switch with sounds for sending forth pleasant sounds or music when the switch is turned on.

The switch with sounds in the present invention includes a switch body provided therein with a recording device and a time controller that are electrically connected with the switch body.

The switch with sounds of this invention can be installed on various kinds of electric appliances.

### BRIEF DESCRIPTION OF DRAWINGS

This invention will be better understood by referring to the accompanying drawings, wherein:

FIG. 1 is a schematic view of a switch with sounds in the present invention; and

FIG. 2 is a block diagram of the switch with sounds in the present invention.

### DETAILED DESCRIPTION OF THE PREFERRED EMBODIMENT

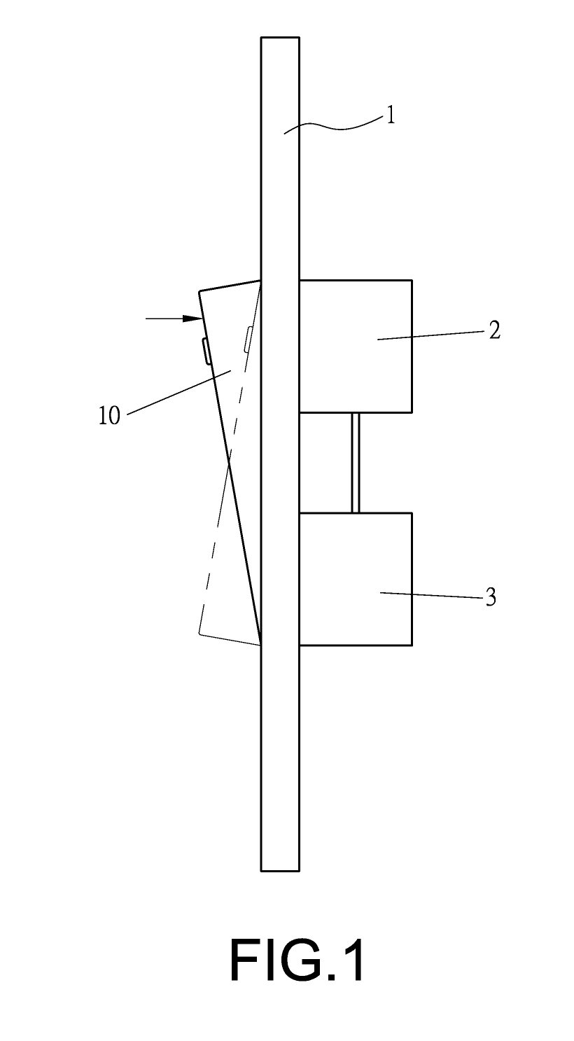

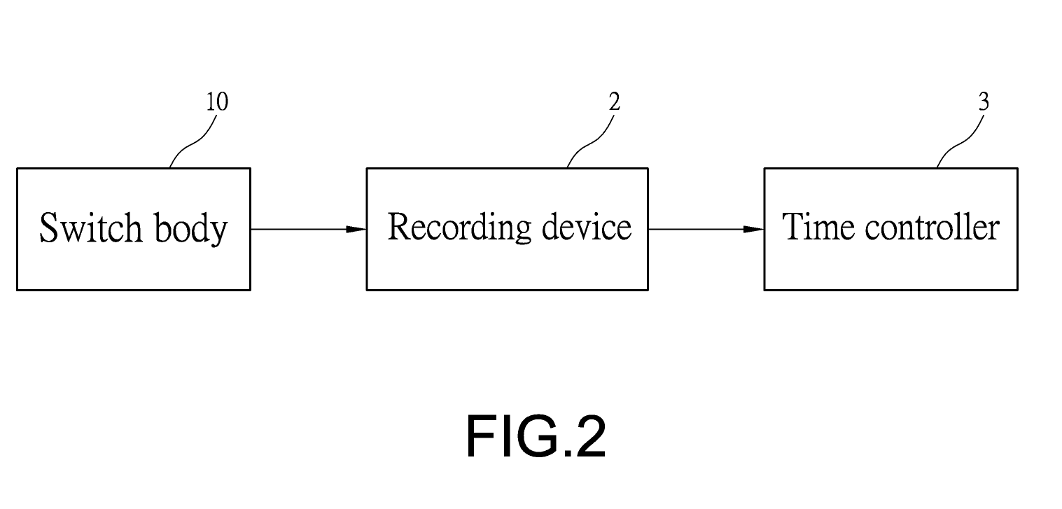

A preferred embodiment of a switch with sounds in the present invention, as shown in FIGS. 1 and 2, includes a faceplate 1 assembled thereon with a switch body 10 and provided therein with a recording device 2 and a time controller 3 that are electrically connected with the switch body 10.

In using, referring to FIGS. 1 and 2, a piece of sounds or music a user likes is recorded beforehand by the recording device 2, and the length of time for sending out the sounds or the music is preset by the time controller 3 and then, the faceplate 1 is secured on a wall where the switch is to be installed. When the switch body 10 on the faceplate 1 is switched on, the recording device 2 will be started to send forth the sounds or the music recorded in advance. Thus, when turning on the switch body 10, a person will get a feeling of warmth and pleasure, relaxed and released from stress, and after the switch body 10 is turned on, the sounds or the music will not stop until the time preset by the time controller 3. Combined with pleasant sounds or music, the switch of this invention is able to get rid of the monotony of a conventional switch that always make a dull and monotonous impression on a person who turns it on, thus adding interest to the action of its turning, eliminating a lonely feeling when a person comes back home alone and easing exhaustion caused by working all day long.

In addition, the switch with sounds of this invention can be installed on various kinds of electric appliances to send out pleasant sounds or music for increasing fun of turning on the switch.

While the preferred embodiment of the invention has been described above, it will be recognized and understood that various modifications may be made therein and the appended claims are intended to cover all such modifications that may fall within the spirit and scope of the invention.

What is claimed is:

1. A switch with sounds comprising a switch body, said switch body provided therein with a recording device and a time controller, said recording device and said time controller electrically connected with said switch body.

2. A switch with sounds as claimed in claim 1, wherein said switch body, said recording device and said time controller are installed on various kinds of electric appliances.
